(19) United States
(12) Patent Application Publication
(10) Pub. No.: US 2023/0264315 A1
(43) Pub. Date: Aug. 24, 2023

(54) ROBOTIC REPAIR CONTROL SYSTEMS AND METHODS

(71) Applicant: 3M INNOVATIVE PROPERTIES COMPANY, St. Paul, MN (US)

(72) Inventors: Kazuma Nuno, St. Paul, MN (US); Yasushi Fujiwara, Kanagawa (JP); Ryogo Kawai, Kanagawa (JP)

(21) Appl. No.: 18/005,614

(22) PCT Filed: Jul. 14, 2021
(86) PCT No.: PCT/IB2021/056333

§ 371 Date: Jan. 16, 2023

Related U.S. Application Data
(60) Provisional application No. 62/705,800, filed on Jul. 16, 2020.

(51) Int. Cl. B24B 1/00; B24B 7/07; B24B 23/02; B24B 49/00; B24B 49/16; B24B 51/00

(52) U.S. Cl. CPC B24B 1/00; B24B 7/07; B24B 23/028; B24B 49/006; B24B 49/16; B24B 51/00; B25J 11/0065

(57) ABSTRACT

A grinding setting selection system for a robotic grinding system is presented. The system includes an abrasive rotational speed retriever that retrieves a current rotational speed of a grinder in the robotic grinding system. The system also includes an end effector load retriever that receives a current end effector load of an end effector in the robotic grinding system. The system also includes a material removal predictor that, based on the retrieved rotational speed and the end effector road, predicts a material removal rate. The system also includes a setting adjuster that, based on the predicted removal rate, provides a setting adjustment for the robotic grinding system. The setting adjustment alters a mechanical setting of the robotic grinding system. The system also includes a setting communicator that communicates the setting adjustment to the robotic grinding system.

### BACKGROUND

Surface repair and other grinding operations are an area of abrasive operations still being automated. Historically, human operated abrading devices provide more consistent control. Human operation is time consuming, inconsistent, and labor intensive. While robotic systems are known, techniques are desired for better control over automated grinding processes.

### SUMMARY

A grinding setting selection system for a robotic grinding system is presented. The system includes an abrasive rotational speed retriever that retrieves a current rotational speed of a grinder in the robotic grinding system. The system also includes an end effector load retriever that receives a current end effector load of an end effector in the robotic grinding system. The system also includes a material removal predictor that, based on the retrieved rotational speed and the end effector road, predicts a material removal rate. The system also includes a setting adjuster that, based on the predicted removal rate, provides a setting adjustment for the robotic grinding system. The setting adjustment alters a mechanical setting of the robotic grinding system. The system also includes a setting communicator that communicates the setting adjustment to the robotic grinding system.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document.

FIG. 1 illustrates a robotic repair cell in which embodiments herein may be useful.

FIGS. 2A and 2B illustrate schematic representation of removal rates for human and robotic grinding operations over time.

FIGS. 3A and 3B illustrate robotic grinding system components in accordance with embodiments herein.

FIG. 4 illustrates parameters of interest for determining settings of grinding operation systems in accordance with embodiments herein.

FIG. 5 illustrates a method of adjusting grinding operation parameters in accordance with embodiments herein.

FIG. 6 illustrates a grinding setting selection system in accordance with embodiments herein.

FIG. 7 is a grinder setting selection system architecture.

FIGS. 8-9 show examples of mobile devices that can be used in the embodiments shown in previous Figures.

FIG. 10 is a block diagram of a computing environment that can be used in embodiments shown in previous Figures.

FIGS. 11-12 illustrate removal rate charts discussed in greater detail in the Examples.

### DETAILED DESCRIPTION

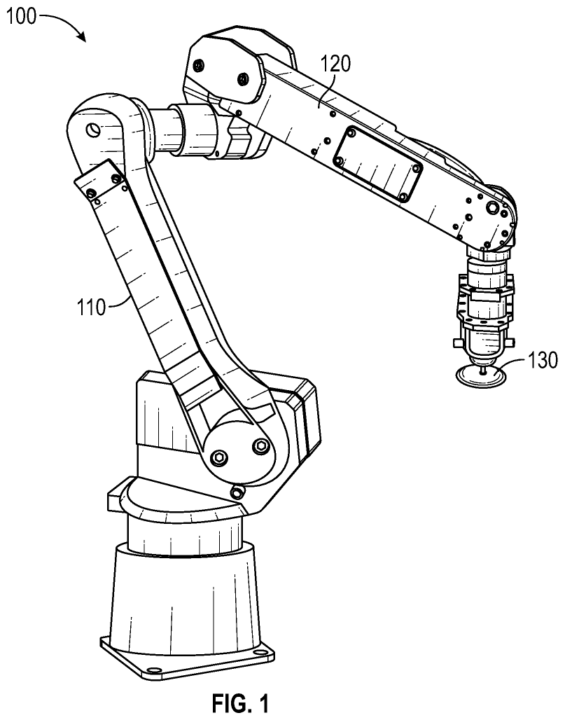

FIG. 1 is a schematic of a robotic grinding system in which embodiments of the present invention are useful. System 100 includes a robotic unit 110 with a robotic arm 120 which is coupled to an abrasive grinding element 130. The robotic grinding system 100 of FIG. 1 is illustrated within a robotic cell.

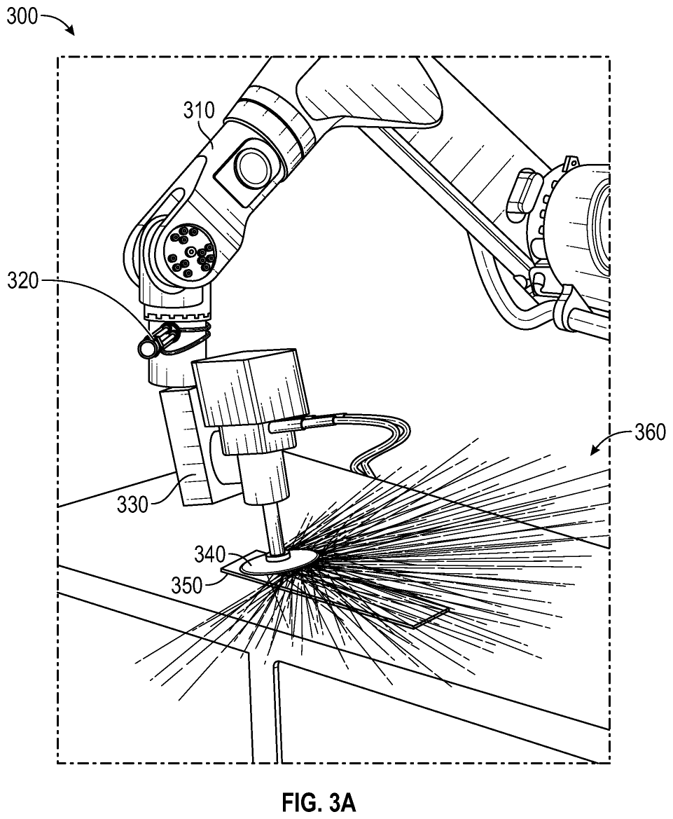

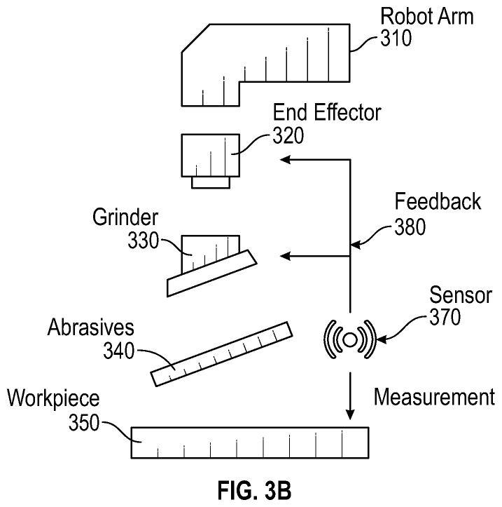

Robotic unit 100 may include at least one force control unit that can be aligned with an end-effector, discussed in greater detail in FIGS. 3A-3B. As illustrated herein, an end effector is coupled to a single too, however, other embodiments may include the end effector coupled to two or more tools, as further described in co-owned U.S. Provisional Patent Application 62/940,950, filed Nov. 27, 2019. Other suitable arrangements are also expressly contemplated.

The current state of the art in many grinding operations is for a human operator, with or without the aid of a power tool, to apply an abrasive article to a worksurface during a grinding operation. An expert human executing such an operation leverages many hours of training while simultaneously utilizing their senses to monitor the progress of the repair and make changes accordingly. Such sophisticated behavior is hard to capture in a robotic solution.

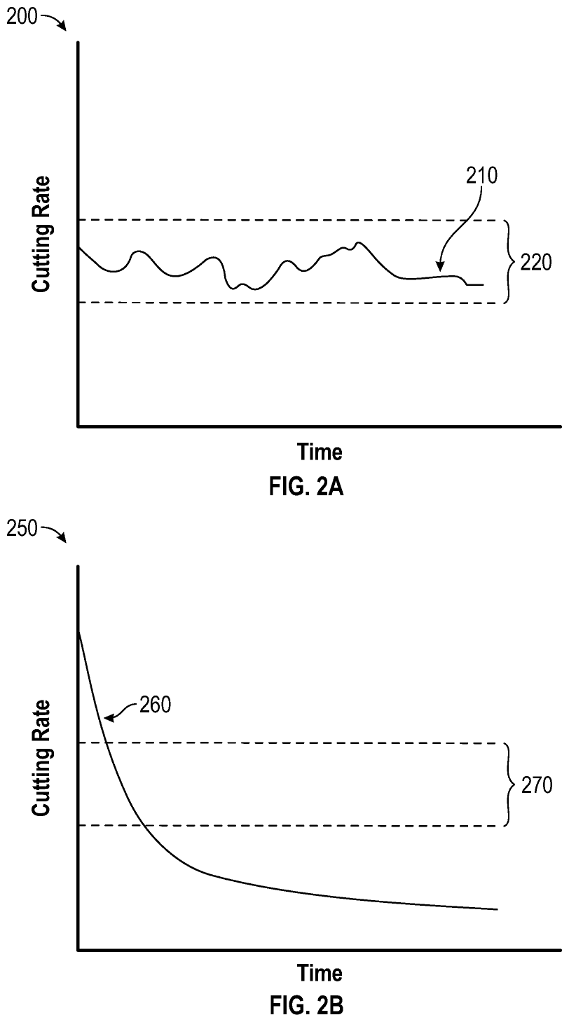

Human grinding work is gradually being replaced by robotic systems like that illustrated in FIG. 1 and FIG. 3A. This reduces labor costs, but results in inconsistent cutting rates after repeated operations. As illustrated in FIG. 2A, a human worker may have a variable removal rate over time, but can keep the removal rate in a consistent range by dynamically changing the grinding conditions based on conditions of the disc and the work material, which can be estimated from visuals or reactions of the grinding system. In contrast, as illustrated in FIG. 2B, a robotic unit experiences a predictable decrease in cutting rate over time. This is because, in conventional methods, the system continues to grind under the same set up—e.g. the same arm angle, translational speed, rotational speed and press force—from operation to operation, regardless of the wear of the disc. In contrast, human operators are able to adjust dynamically based on visible wear of the abrasive, tactile feedback, or based on grinding behavior during an operation.

It is desired to have a robotic system that can better detect and respond to changing conditions during a grinding operation. Many existing systems are able to vary input parameters (rotational or lateral speed, arm angle, press force), however it is desired to have a system that can adjust these inputs based on real-time known, or predicted, grinding conditions. For example, it is desired to have a system that can adjust operational parameters based on a detected wear rate or wear amount of the abrasive article, the color of the abrasive article, the sight and sound of the sparking during the abrasive operation, etc. Many of these parameters are particularly difficult to measure in-situ.

FIGS. 3A and 3B illustrate robotic grinding system components in accordance with embodiments herein. Similar components are so numbered in FIGS. 3A and 3B. The robotic grinding unit may be stationary, in some embodiments, or may be mobile, in other embodiments. While discussion is limited herein to movement ranges and abilities of an arm component 310, it is expressly contemplated that a robotic grinding unit 300 may have multiple moveable arm components extending from a base (not shown in FIG. 3A) to a force control unit. A base of robotic grinding unit 300 may also have multiple degrees of freedom in which to move, as may each of its articulated components.

Robotic arm 310 may be moveable in both a lateral direction, e.g. toward or away from a base of the robotic grinding unit 300. An end effector 320 may be coupled to robotic arm 310, either directly or through a force control unit, for example, which may control movement in a rotational direction. End effector 320 can exert a pressing force through grinder 330, forcing abrasive 340 into contact with workpiece 350. Grinder 330 can rotate, as illustrated in FIG. 3B, to position abrasive 340 at an angle with respect to workpiece 350. Abrasive 340 can be selected from any suitable abrasive article including bonded abrasive articles, nonwoven abrasive articles, or coated abrasive articles.

System 300 may include one or more sensors 370. Among other parameters, a sensor 370 may be capable of detecting information related to a real-time material removal rate of abrasive 340 from workpiece 350. Sensor 370 may, for example, based on detectable information 360 about a current abrasive operation, send feedback 380 to one or more components of grinding system 300 so that grinding system parameters can be adjusted to maintain a desired removal rate. The workpiece may be any suitable material, such a metal, wood, or other material.

Detectable information 360 may include, as illustrated in FIG. 3A, an abrasive spark color or grinding sound generated by a current abrasive operation. Additionally, a reaction force, exhibited by the abrasive reacting to the force exerted on grinder 330 by end effector, may be detectable.

Ideally, a real time removal rate is used as the basis for an algorithmic adjustment to current grinding system parameters. Several different options exist for measuring the removal rate in-situ. For example, after each grinding pass, a weight of the workpiece could be measured. Additionally, when a force is removed from the abrasive article, its weight may also be detectable by a force control unit. However, the weight differences are small, and a high resolution measurement system would be needed to detect an accurate weight difference. Debris from a grinding operation may also need to be removed in order to accurately measure the wear rate.

Another option for measurement of a wear rate is to use a laser profiler which detects a difference in shape of the abrasive article or the workpiece itself. For example, a weld height difference may be detected in between removal operations. However, such a system would be expensive, difficult to implement, and would still require stopping the grinding operation and removing debris to accurately measure.

Described herein is a prediction model that can be used to predict a real-time removal rate of an abrasive article and, based on the detected real-time removal rate, adjust grinding system parameters of a grinding system to maintain a consistent removal rate over the use of the abrasive article. The Examples discussed in greater detail below illustrate how the prediction model fits to feedback from a series of actual grinding results.

One basis for understanding material removal, and the basis for the systems and methods described herein is the well-known Preston's equation of material removal (Equation 1, below) that expresses the instantaneous rate of material removal (cut) as a product of pressure, relative velocity, and a constant (Preston's constant) defined in part by the complex interaction between the abrasive, substrate, and any cutting fluid.

$$\frac{dh}{dt} = {k}_{p} {pv}_{rel} \qquad Equation 1$$

Here kₚ is a constant dependent on the abrasive/surface interaction, p is the pressure at any given point on the surface, and vᵣₑₜ is the relative velocity of the abrasive on the surface at that point. The term dh/dt is the rate at which material is removed. From Equation 1, along with the assumption that the abrasive and any cutting fluid is predetermined and held constant for the duration of a defect repair (i.e., kₚ fixed), the domain-specific inputs of instantaneous cut are applied force (and resulting pressure) and tool velocity (rotational, orbital, etc.). Total cut is determined via the integral of instantaneous cut over time distributed accordingly as a function of any macro motion of the end effector by the robot. Embodiments herein provide methods for predicting the Preston's coefficient (kₚ) using parameters that affect the removal rate, which is the left side of the Preston's Law, and can be measured in-situ.

In this respect, material removal over a surface can be expressed as an integral of the pressure distribution over the abrasive media (created by interaction with the substrate) scaled by the relative velocities between the abrasive and substrate and Preston's constant.

The constant term kₚ changes as the disc life erodes. A number of different parameters can be measured during a grinding operation, many of which can be correlated to a material removal rate. For example, rotational or lateral speed of the robot arm, grinder motor power, load, reaction force, wear amount, contact angle, are all measurable by sensors in current grinding systems. These variables are transformed into values that describe the abrasive article condition. A regression model is then used to predict the removal rate. A regression model is used to create an estimated distribution of possible values of the constant term kₚ instead of estimating the coefficient itself. Integrating these terms through time gives the total cut at that point.

Systems and methods herein apply a regression to kₚ, using the input of other measurable parameters such as, for example, motor power, reaction force, wear amount, contact angle etc.

Various regression models may be used to predict kₚ, such as either a linear regression model or a nonlinear regression model. Some possible models may include, but are not limited to: a polynomial regression model, a support vector regression model, a Gaussian process regression model, a ridge regression model, a lasso regression model, an elastic-net regression model, a nearest neighbors regression model, a naïve Bayes regression model, a decision tree regression model, a random forest regression model, a neural network regression model.

Using such a prediction model, a removal rate of the abrasive article can be estimated and, based on that estimate, parameters of the grinding system can be adjusted. For example, a removal rate can be increased by increasing a pressing force of the end effector 320. An angle of the grinder 330 may be increased, with respect to the workpiece, in order to intensify a grinding force. A load may be increased to increase a removal rate. A rotational speed may also be increased to increase a removal rate. An increasing wear amount will reduce a removal rate. Different parameters may be adjusted to reduce or respond to abrasive sparking.

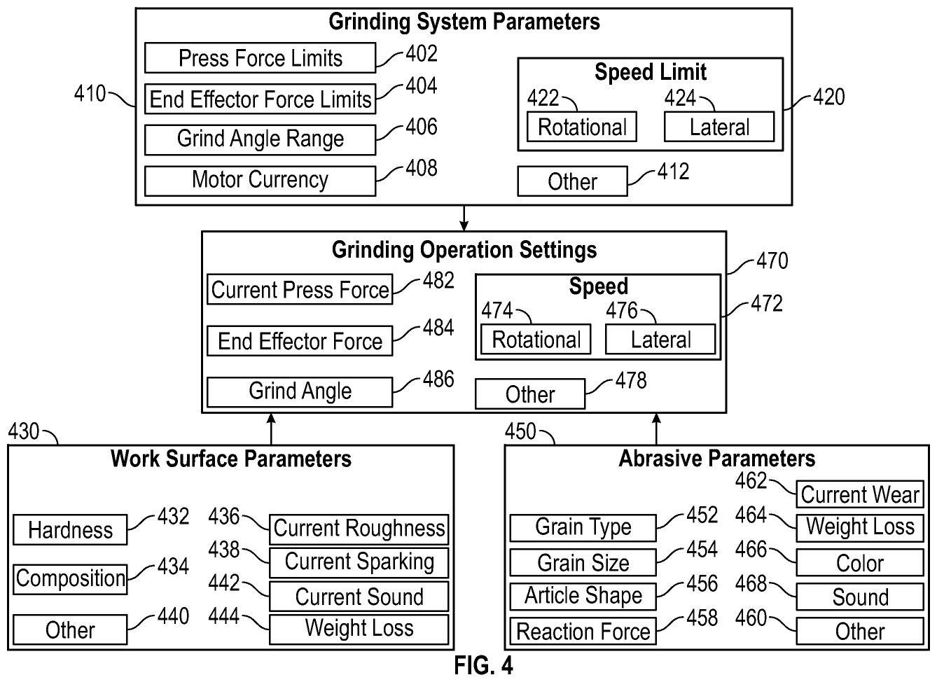

FIG. 4 illustrates parameters of interest for determining settings of grinding operation systems in accordance with embodiments herein. Settings 470 for a grinding operation illustrate some, but not all, of the input settings that may be adjusted based on known parameters 410 about the grinding system, parameters 430 related to a worksurface, and parameters 450 known about an abrasive article.

Grinding system parameters 410 include force limits 404 that can be exerted by an end effector unit, a range 406 of angle positions that a grinder may take, a grinder motor power 408, upper and lower functional limits on speed 420 of the robot arm, including lateral movement 424 and rotational movement 422. A grinding system may also have other parameters 412, such as sensor feedback parameters for sensors associated with a grinding system.

A worksurface may also have parameters 430 that can affect settings 470 for a grinding operation. For example, a worksurface has a composition 434, a hardness 432, and other physical parameters 440. Additionally, a worksurface has a current surface roughness 436, and a current weight loss 444 during an abrading operation.

An abrasive article may also have parameters 450 relevant to a grinding operation including abrasive grain type 452, size 454, and a shape 456 of the overall article. Other physical parameters 460 may be relevant. The abrasive article may have a current weight loss 464 from an original or a pre-operation weight. The abrasive article may have a color 466 which may change during an abrasive operation.

Additionally, because of the interaction between the abrasive article and the worksurface during the grinding operation, interaction responses 480 may be observed. For example, the worksurface may be exhibiting sparking 438, which may have an associated color, amount, or pattern, and may also be exhibiting a current grinding sound 442. The abrasive article also exhibits a reaction force as a result of the interaction.

Grinding operation settings 470 are set initially for each grinding operation. Some can be adjusted in-situ during a grinding operation. Some can be adjusted in between operations. In some embodiments, each can be adjusted based on feedback about worksurface parameters 430 and abrasive parameters 450 received during a grinding operation. For example, a current press end effector force 484 can be increased or decreased, a grind angle 486 can be increased or decreased to change a contact angle of an abrasive article with the worksurface. A speed 472 of the robotic arm can be adjusted, so that both a rotational speed 474 and a lateral speed 476 can be increased or decreased. Other parameters 478 may also be adjusted.

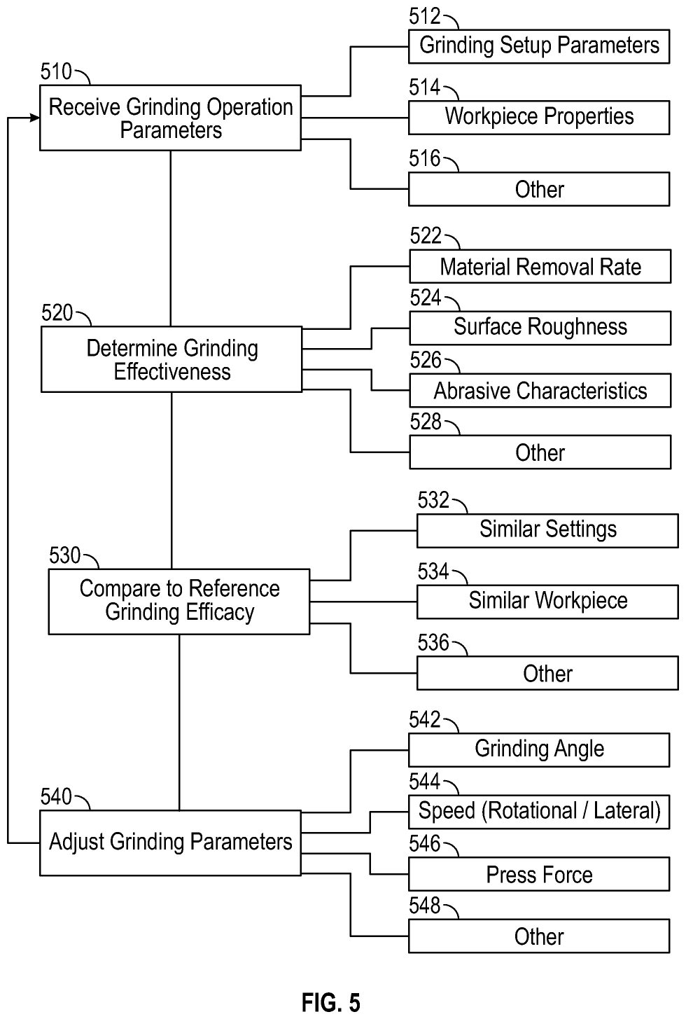

FIG. 5 illustrates a method of adjusting grinding operation parameters in accordance with embodiments herein. The method illustrated in FIG. 5 may be implemented as an API, for example, that runs in the background automatically without any interaction needed from an operator. However, in another embodiment, one or more steps of the method illustrated in FIG. 5 is at least partially displayed to an operator of a robotic grinding system. The operator may only be able to see changes made, in some embodiments, or may only see that current grinding operation parameter values have changed. In other embodiments, the operator can override changes being made. In other embodiments, the operator must approve suggested changes before they are implemented.

In block 510, current grinding operation parameters are received. Current parameters may include setup parameters 512 for a grinding system, workpiece properties 514 of a current workpiece, and other information 516. For example, sensor feedback may be received about a current color or sound of an abrasive article, a current spark color or intensity from the workpiece, or other mechanical information, such as feedback regarding a reaction force of the abrasive article. Setup parameters may include lateral or rotational speed of a robotic arm, an end effector load, or other information about a current grinding operation.

In block 520, grinding effectiveness is determined. Detecting current grinding effectiveness may include calculating a predicted material removal rate 522 based on the retrieved grinding operation information. For example, as described above, a material removal rate can be predicted using a modified Preston's law calculation using a current rotational speed, wear amount, and an end effector load. The material removal rate predicted may be improved using a current grinder motor power, in some embodiments. The material removal rate may be more accurately predicted by using a current reaction force of the abrasive article exerted on the grinding system. Grinding effectiveness may also be determined based on a current or estimated surface roughness 524 of the workpiece. Determining grinding effectiveness may also take into account current characteristics of the abrasive 526, such as the abrasive color, sound, and whether sparking is occurring and, if so, the characteristics of the sparking. For example, the abrasive may change color based on an amount of useful life remaining. A sound or color of sparking may also indicate burning or other undesirable abrasive activity. Other characteristics 528 may also be considered when determining a current grinding effectiveness.

In block 530, a current grinding effectiveness is compared against a reference to determine whether the grinding effectiveness can be improved. For example, a current grinding effectiveness may be compared to other grinding operations conducted by the same, or similar, grinding system under similar setup parameters, as indicated in block 532. If the current effectiveness is lower than the reference grinding efficacy, then changes may be needed to increase grinding efficiency. Similarly, the comparison may be conducted to similar grinding operations on a similar workpiece, as indicated in block 534. Other parameters may also be considered, as indicated in block 536.

In some embodiments, a comparison step, as illustrated in block 530, is not needed, and parameters are adjusted, as indicated by arrow 550, directly based on a determined grinding effectiveness using Preston's Law as described above. For example, if a calculated removal rate is lower than desired, one or more parameters can be adjusted to either increase the estimated distribution of kₚ or the rate over time, by adjusting the speed or the contact force (p) applied by the end effector.

In block 540, grinding parameters are adjusted. For example, a grinding angle 542 may be increased or decreased based on the grinding efficiency comparison. A rotational or lateral speed 544 of the grinder may be adjusted. A press force 546 of the end effector may be increased or decreased. Other parameters 548 may also be adjusted.

The steps illustrated in FIG. 5 may be repeated periodically by a robotic grinding system, as illustrated by arrow 560. For example, the method may be repeated at least once during every grinding operation, or at least twice, or even more frequently. In another embodiment, the method may be repeated periodically, for example once every hour, once every minute, or once every second.

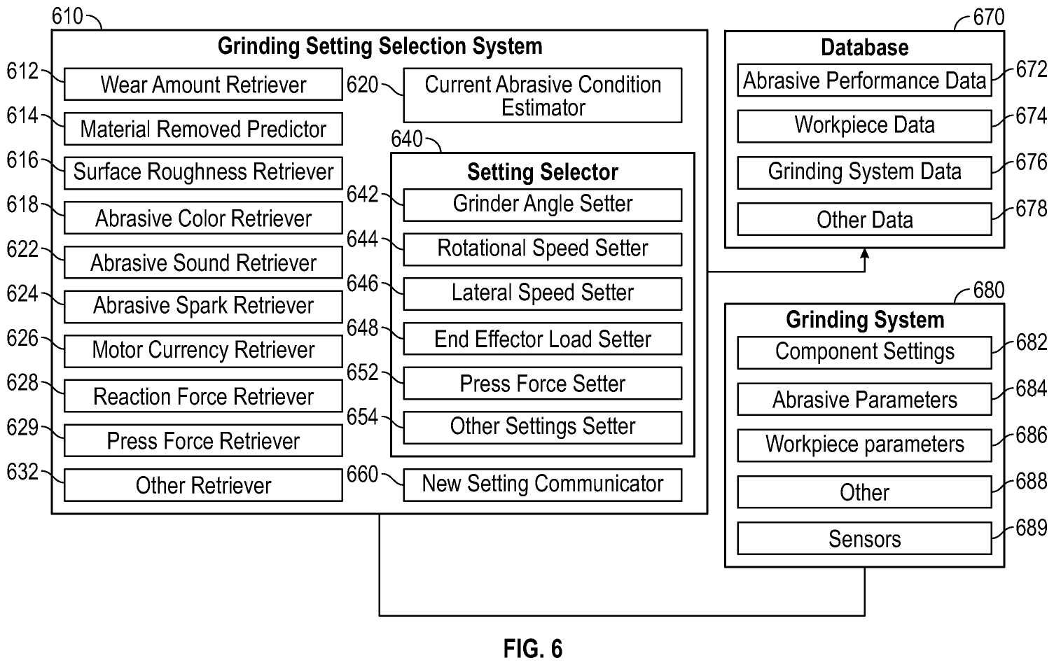

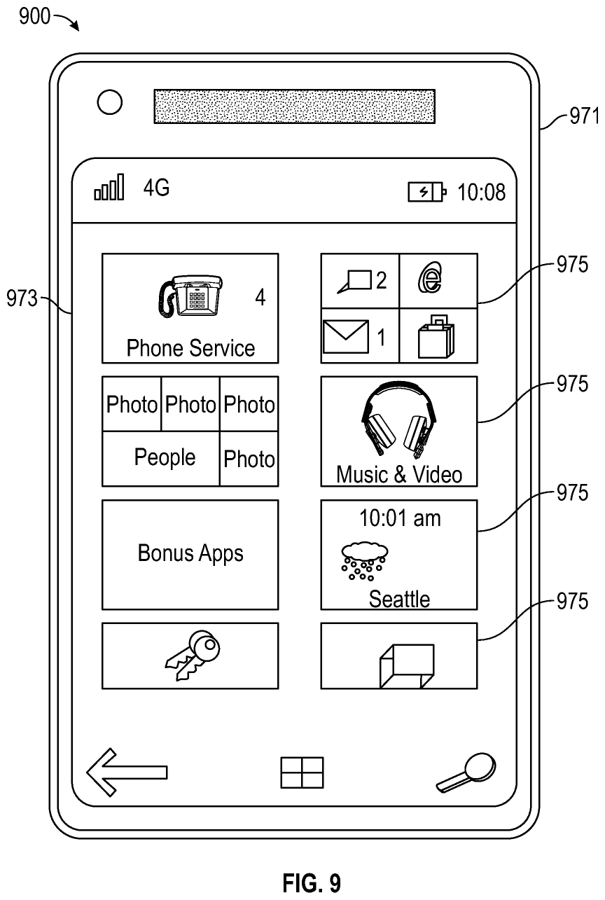

FIG. 6 illustrates a grinding setting selection system in accordance with embodiments herein. FIG. 6 illustrates one example setup of a grinding setting selection system, however others are expressly contemplated. For example, a grinding setting selection system 610 may be part of grinding system 680, or may be located on a remote device, or accessed through a wireless or cloud-based network. As discussed below with respect to FIG. 9, a grinding setting selection system may be accessible through a graphical user interface on a computing device.

A robotic grinding system 680 includes a plurality of components, each with one or more settings 682. The system also includes at least one abrasive article with a plurality of abrasive parameters 684. The system also includes a workpiece, operated on by the grinding system, the workpiece having a plurality of workpiece parameters 686. The system 680 may also have other components 688.

Grinding setting selection system 610 may also retrieve information from a database 670, which may be stored locally, e.g. as part of a grinding system 680 or as part of a computing unit including grinding setting selection system 610. Database 670 may also be located, in another embodiment, remotely from either grinding system 680 or grinding setting selection system 610, accessible using a wireless or cloud network. Database 670 may include abrasive performance data 672, which may include performance information, such as cutting rates, wear rates, and material composition, of a plurality of abrasives. Database 670 may also include workpiece data 674, which may include information about a workpiece, such as composition, hardness, thickness, 3D structure, or other relevant information. Database 670 may also include grinding system data 676, such as historic or expected grinding efficiency rates, expected or historic material removal rates, or other information relevant to a given operation. Database 670 may also include other data 678.

Grinding setting selection system 610 includes a wear amount retriever 612 that retrieves a wear condition of the abrasive article. Grinding setting selection system 610 may also include a surface roughness retriever that retrieves information about a current roughness of a workpiece surface. Grinding setting selection system 610 may also include an abrasive color retriever 618, which retrieves information about a current color of an abrasive article, which may indicate a wear amount of the abrasive article, or a current temperature of the grinding information. Similarly, sound retriever 622 may retrieve and analyze a sound of a grinding operation for abnormalities, and an abrasive spark retriever 624 may retrieve information about whether, how much, and what color sparking is occurring during a grinding operation. Grinding setting selection system 610 may also include a grinder motor power retriever 626 which retrieves a current grinder motor power of a grinding motor. Grinding setting selection system 610 may also include a reaction force retriever 628 which retrieves a current reaction force from the abrasive article on the grinding system. Grinding setting selection system 610 may also include a press force retriever 629, which retrieves a press force of the end effector acting on the abrasive article. Other information about a grinding operation may also be retrieved by other retriever 632.

The information retrievers illustrated in FIG. 6 may retrieve information about current grinding operations from sensors 689 associated with grinding system 680, such as optical, force, or other sensors. The sensors may be part of grinding system 680, part of a cell associated with grinding system 680, or may be located in another suitable position.

Based on the information retrieved, a material removal predictor 614 may predict a current material removal rate for grinding system 680. Additionally, a current abrasive condition estimator 620 may estimate a current condition of the abrasive article, including a level of wear and a temperature of the abrasive article.

Based on the material removal prediction rate and the abrasive condition, a setting selector 640 may alter settings for grinding system 680. For example, an angle of the grinder may be adjusted by grinder angle setter 642. A speed of the grinder may also be adjusted, by rotational speed setter 644 or lateral speed setter 646. An end effector load may be adjusted by end effector load setter 648. A press force of the end effector may also be adjusted by press force setter 652. Other settings may be adjusted by the other settings setter 654. Settings may be adjusted to increase an efficiency of grinding system 680, for example to increase a predicted material removal rate, or to reduce a risk of burning the workpiece.

The new settings are communicated from grinding setting selection system 610 to grinding system by new setting communicator 660, which may automatically implement them within grinding system 680.

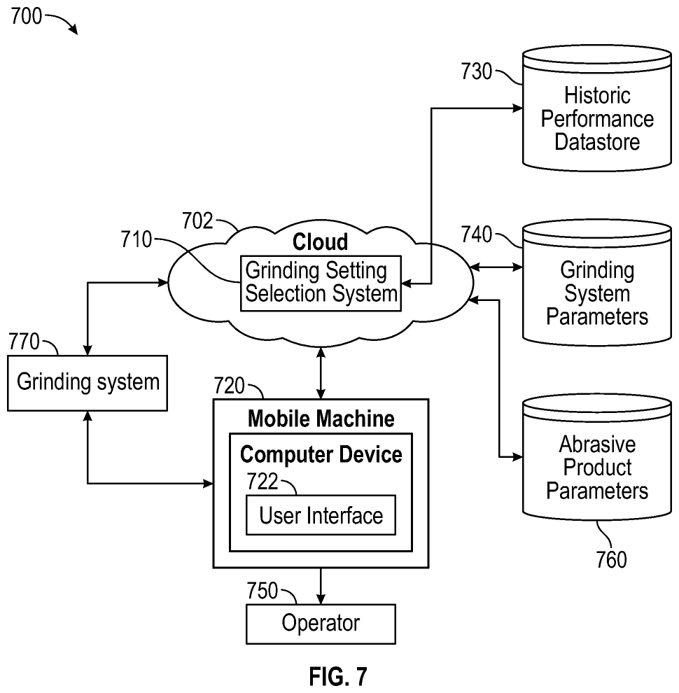

FIG. 7 is a block diagram of a grinding setting selection system in a cloud-based architecture. The remote server architecture 700 illustrates one embodiment of an implementation of a grinding setting selection system 710. As an example, remote server architecture 700 can provide computation, software, data access, and storage services that do not require end-user knowledge of the physical location or configuration of the system that delivers the services. In various embodiments, remote servers can deliver the services over a wide area network, such as the internet, using appropriate protocols. For instance, remote servers can deliver applications over a wide area network and they can be accessed through a web browser or any other computing component. Software or components shown or described in FIGS. 1-6 as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, they can be provided by a conventional server, installed on client devices directly, or in other ways.

In the example shown in FIG. 7, some items are similar to those shown in earlier figures. FIG. 7 specifically shows that a grinding setting selection system can be located at a remote server location 702. Therefore, computing device 720 accesses those systems through remote server location 702. Operator 750 can use computing device 720 to access user interfaces 722 as well. Embodiments described herein have focused on systems and methods that automatically retrieve data to estimate a current material removal rate and, based on that estimation, adjust parameters of a current grinding operation, all in-situ. However, it is expressly contemplated that the retrieved data, the adjustments, or other information may be presented on user interface 722 for action or approval from an operator 750. For example, an operator 750 may need to approve a proposed parameter adjustment before it is effected in the grinding system. Alternatively, the operator may be able to provide changes to the proposed parameter adjustments. Or, in some embodiments, the operator 750 may only be able to view current parameters.

FIG. 7 also depicts another example of a remote server architecture. FIG. 7 shows that it is also contemplated that some elements of systems described herein are disposed at remote server location 702 while others are not. By way of example, storage 730, 740 or 760 or grinding system 770 can be disposed at a location separate from location 702 and accessed through the remote server at location 702. Regardless of where they are located, they can be accessed directly by computing device 720, through a network (either a wide area network or a local area network), hosted at a remote site by a service, provided as a service, or accessed by a connection service that resides in a remote location. Also, the data can be stored in substantially any location and intermittently accessed by, or forwarded to, interested parties. For instance, physical carriers can be used instead of, or in addition to, electromagnetic wave carriers.

It will also be noted that the elements of systems described herein, or portions of them, can be disposed on a wide variety of different devices. Some of those devices include servers, desktop computers, laptop computers, imbedded computer, industrial controllers, tablet computers, or other mobile devices, such as palm top computers, cell phones, smart phones, multimedia players, personal digital assistants, etc. Any suitable computing device with a display may be able to service as computing device 1520 with user interface 1522.

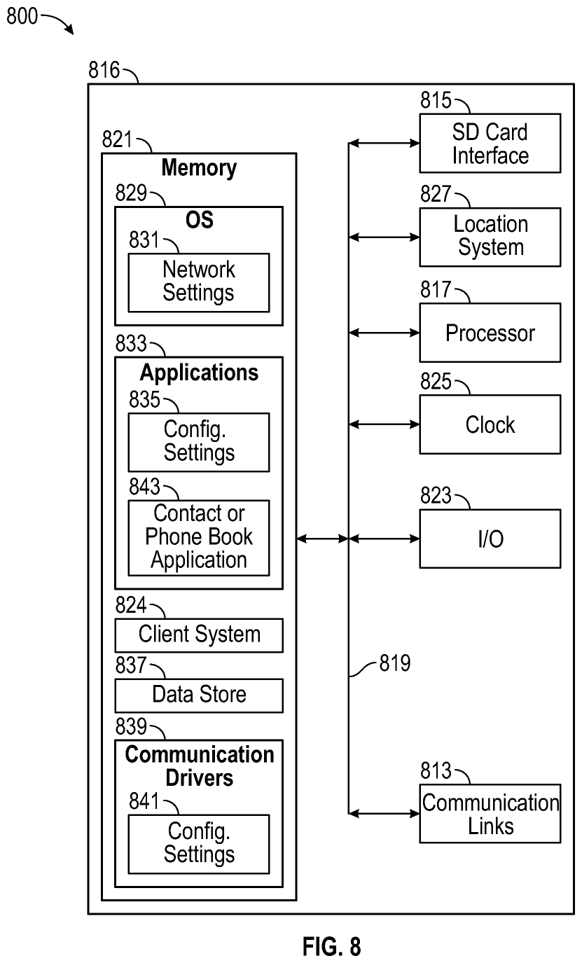

FIG. 8 is a simplified block diagram of one illustrative example of a handheld or mobile computing device that can be used as a user's or client's handheld device 816 (e.g., as computing device 720 in FIG. 7), in which the present system (or parts of it) can be deployed. For instance, a mobile device can be deployed in the operator compartment of computing device 720 for use in generating, processing, or displaying the data. FIG. 9 is another example of a handheld or mobile device.

FIG. 8 provides a general block diagram of the components of a client device 816 that can run some components shown and described herein. Client device 816 interacts with them, or runs some and interacts with some. In the device 816, a communications link 813 is provided that allows the handheld device to communicate with other computing devices and under some embodiments provides a channel for receiving information automatically, such as by scanning Examples of communications link 813 include allowing communication though one or more communication protocols, such as wireless services used to provide cellular access to a network, as well as protocols that provide local wireless connections to networks.

In other examples, applications can be received on a removable Secure Digital (SD) card that is connected to an interface 815. Interface 1615 and communication links 813 communicate with a processor 817 (which can also embody a processor) along a bus 819 that is also connected to memory 821 and input/output (I/O) components 823, as well as clock 825 and location system 827.

I/O components 823, in one embodiment, are provided to facilitate input and output operations and the device 816 can include input components such as buttons, touch sensors, optical sensors, microphones, touch screens, proximity sensors, accelerometers, orientation sensors and output components such as a display device, a speaker, and or a printer port. Other I/O components 823 can be used as well.

Clock 825 illustratively comprises a real time clock component that outputs a time and date. It can also provide timing functions for processor 817.

Illustratively, location system 827 includes a component that outputs a current geographical location of device 816. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 821 stores operating system 829, network settings 831, applications 833, application configuration settings 835, data store 837, communication drivers 839, and communication configuration settings 841. Memory 821 can include all types of tangible volatile and non-volatile computer-readable memory devices. It can also include computer storage media (described below). Memory 821 stores computer readable instructions that, when executed by processor 817, cause the processor to perform computer-implemented steps or functions according to the instructions. Processor 817 can be activated by other components to facilitate their functionality as well.

FIG. 9 shows that the device can be a smart phone 971. Smart phone 971 has a touch sensitive display 973 that displays icons or tiles or other user input mechanisms 975. Mechanisms 975 can be used by a user to run applications, make calls, perform data transfer operations, etc. In general, smart phone 971 is built on a mobile operating system and offers more advanced computing capability and connectivity than a feature phone. The grinding setting selection system may be an installed application, or accessible through a website on the Internet, or another suitable configuration accessible by smart device 971.

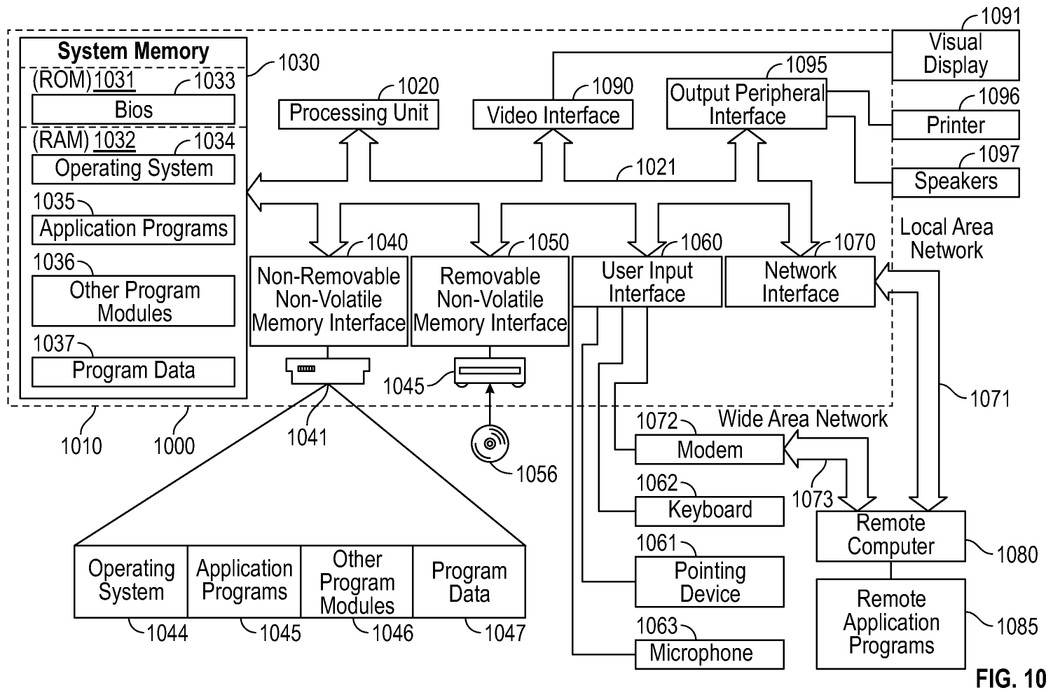

FIG. 10 is a block diagram of a computing environment that can be used in embodiments shown in previous Figures.

FIG. 10 is one example of a computing environment in which elements of systems and methods described herein, or parts of them (for example), can be deployed. With reference to FIG. 10, an example system for implementing some embodiments includes a general-purpose computing device in the form of a computer 1010. Components of computer 1010 may include, but are not limited to, a processing unit 1020 (which can comprise a processor), a system memory 1030, and a system bus 1021 that couples various system components including the system memory to the processing unit 1020. The system bus 1021 may be any of several types of bus structures including a memory bus or memory controller, a peripheral bus, and a local bus using any of a variety of bus architectures. Memory and programs described with respect to systems and methods described herein can be deployed in corresponding portions of FIG. 10.

Computer 1010 typically includes a variety of computer readable media. Computer readable media can be any available media that can be accessed by computer 1010 and includes both volatile/nonvolatile media and removable/non-removable media. By way of example, and not limitation, computer readable media may comprise computer storage media and communication media. Computer storage media is different from, and does not include, a modulated data signal or carrier wave. It includes hardware storage media including both volatile/nonvolatile and removable/non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1010. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 1030 includes computer storage media in the form of volatile and/or nonvolatile memory such as read only memory (ROM) 1031 and random access memory (RAM) 1032. A basic input/output system 1033 (BIOS) containing the basic routines that help to transfer information between elements within computer 1010, such as during start-up, is typically stored in ROM 1031. RAM 1032 typically contains data and/or program modules that are immediately accessible to and/or presently being operated on by processing unit 1020. By way of example, and not limitation, FIG. 10 illustrates operating system 1034, application programs 1035, other program modules 1036, and program data 1037.

The computer 1010 may also include other removable/non-removable and volatile/nonvolatile computer storage media. By way of example only, FIG. 10 illustrates a hard disk drive 1041 that reads from or writes to non-removable, nonvolatile magnetic media, nonvolatile magnetic disk 1052, an optical disk drive 1055, and nonvolatile optical disk 1056. The hard disk drive 1041 is typically connected to the system bus 1021 through a non-removable memory interface such as interface 1040, and optical disk drive 1055 are typically connected to the system bus 1021 by a removable memory interface, such as interface 1050.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 10, provide storage of computer readable instructions, data structures, program modules and other data for the computer 1010. In FIG. 10, for example, hard disk drive 1041 is illustrated as storing operating system 1044, application programs 1045, other program modules 1046, and program data 1047. Note that these components can either be the same as or different from operating system 1034, application programs 1035, other program modules 1036, and program data 1037.

A user may enter commands and information into the computer 1010 through input devices such as a keyboard 1062, a microphone 1063, and a pointing device 1061, such as a mouse, trackball or touch pad. Other input devices (not shown) may include a joystick, game pad, satellite receiver, scanner, or the like. These and other input devices are often connected to the processing unit 1020 through a user input interface 1060 that is coupled to the system bus, but may be connected by other interface and bus structures. A visual display 1091 or other type of display device is also connected to the system bus 1021 via an interface, such as a video interface 1090. In addition to the monitor, computers may also include other peripheral output devices such as speakers 1097 and printer 1096, which may be connected through an output peripheral interface 1095.

The computer 1010 is operated in a networked environment using logical connections, such as a Local Area Network (LAN) or Wide Area Network (WAN) to one or more remote computers, such as a remote computer 1080.

When used in a LAN networking environment, the computer 1010 is connected to the LAN 1071 through a network interface or adapter 1070. When used in a WAN networking environment, the computer 1010 typically includes a modem 1072 or other means for establishing communications over the WAN 1073, such as the Internet. In a networked environment, program modules may be stored in a remote memory storage device. FIG. 10 illustrates, for example, that remote application programs 1085 can reside on remote computer 1080.

A grinding setting selection system for a robotic grinding system is presented. The system includes an abrasive rotational speed retriever that retrieves a current rotational speed of a grinder in the robotic grinding system. The system also includes an end effector load retriever that receives a current end effector load of an end effector in the robotic grinding system. The system also includes an in-situ parameter sensor that senses an in-situ grinding parameter in a current grinding operation. The system also includes a material removal predictor that, based on the retrieved rotational speed, the end effector load and the in-situ grinding parameter, predicts an in-situ material removal rate. The system also includes a setting adjuster that, based on the predicted in-situ removal rate, provides a setting adjustment for the robotic grinding system. The setting adjustment alters a mechanical setting of the robotic grinding system. The system also includes a setting communicator that communicates the setting adjustment to the robotic grinding system.

The grinding setting selection system may be implemented such that the in-situ parameter sensor is a grinder motor power sensor that detects a current grinder motor power, and where the material removal predictor predicts the material removal rate based on the current grinder motor power.

The grinding setting selection system may be implemented such that the in-situ parameter sensor is a reaction force sensor that senses a reaction force exerted by an abrasive article on the end effector. The material removal predictor predicts the material removal rate based on the reaction force.

The grinding setting selection system may be implemented such that the material removal rate predictor also predicts the material removal rate based on a press force of the end effector, a grind angle of the grinder, or a lateral speed of a robotic arm.

The grinding setting selection system may be implemented such that the mechanical setting includes a new press force for the end effector, a new rotational speed, or a new grind angle.

The grinding setting selection system may be implemented such that it also includes a worksurface parameter retriever.

The grinding setting selection system may be implemented such that the worksurface parameter retriever retrieves a composition, a hardness or a surface roughness of a worksurface.

The grinding setting selection system may be implemented such that the worksurface parameter retriever retrieves a current sparking condition of a worksurface or a current grinding sound.

The grinding setting selection system may be implemented such that it also includes an abrasive parameter retriever.

The grinding setting selection system may be implemented such that the abrasive parameter retriever retrieves a type, a composition, or a grade of an abrasive article.

The grinding setting selection system may be implemented such that the abrasive parameter retriever retrieves a current abrasive color or current abrasive temperature of an abrasive article.

The grinding setting selection system may be implemented such that based on the retrieved abrasive parameter, an abrasive condition evaluator determines an abrasive condition of an abrasive article.

The grinding setting selection system may be implemented such that the material removal rate predictor includes a regression model.

The grinding setting selection system may be implemented such that the current rotational speed and the end effector load are retrieved directly from the robotic grinding system.

The grinding setting selection system may be implemented such that the setting communicator also communicates the setting adjustment to a database in a format available for later retrieval.

The grinding setting selection system may be implemented such that the setting communicator also communicates the setting adjustment to a user interface generator for display on a user interface.

The grinding setting selection system may be implemented such that the predicted material removal rate is compared to a reference material removal rate. The setting adjuster provides the setting adjustment based on the comparison.

The grinding setting selection system may be implemented such that the current rotational speed and end effector load are periodically retrieved, a predicted material removal rate is calculated, and a settings adjustment provided automatically based on an indication.

The grinding setting selection system may be implemented such that the indication is a period of time, a detected operation start time, or an operator command.

A method of adjusting grinding parameters in a robotic grinding system is presented. The method includes receiving a set of current grinding operation parameters. The set of current grinding operation parameters includes a rotational speed of a grinder a load of an end effector, and a sensed in-situ parameter of the current grinding operation. The method also includes estimating a current material removal rate, using a material removal rate predictor, based on the received set of current grinding operation parameters. The method also includes selecting a set of new grinding operation parameters for the robotic grinding system based on the estimated removal rate. The method also includes automatically adjusting the robotic grinding system from the current grinding operation parameters to the new grinding operation parameters.

The method may be implemented such that it includes calculating a grinding effectiveness, using a grinding effectiveness calculator, by comparing the current material removal rate to an expected material removal rate, and where the selected set of new grinding operation parameters is based on the calculated grinding effectiveness.

The method may be implemented such that the in-situ parameter includes a sensed reaction force experienced by the end effector.

The method may be implemented such that the in-situ parameter includes a sensed current grinder motor power.

The method may be implemented such that the set of current grinding operation parameters also includes a worksurface parameter.

The method may be implemented such that the worksurface parameter includes a worksurface composition, a worksurface hardness, or a surface roughness.

The method may be implemented such that the set of current grinding operation parameters also includes an abrasive article parameter.

The method may be implemented such that the abrasive article parameter is an abrasive article type, composition, or color.

The method may be implemented such that the set of current grinding operation parameters also includes a current grinding sound, a current presence of sparking, or a color of detected sparking.

The method may be implemented such that it includes calculating an abrasive article condition based on the abrasive article parameter. The set of new grinding operation parameters is also based on the calculated abrasive article condition.

The method may be implemented such that the expected material removal rate is a reference material removal rate.

The method may be implemented such that the reference material removal rate includes a range from a lower acceptable material removal rate to an upper acceptable material removal rate.

The method may be implemented such that the material removal rate is calculated using a gaussian process regression.

The method may be implemented such that the steps of receiving, calculating, determining and adjusting done automatically based on an indication.

The method may be implemented such that the indication is a time from last adjustment, a detected time from operation start, or an operator input.

The method may be implemented such that it also includes communicating the set of new grinding operation parameters to the robotic grinding system. The robotic grinding system is remote from the grinding effectiveness calculator.

The method may be implemented such that it also includes storing the set of new grinding parameters in a database.

The method may be implemented such that it also includes communicating the set of new grinding operation parameters to a user interface generator for display on a user interface.

A robotic grinding system is presented that includes an abrasive article configured to contact a worksurface at an angle. The system also includes a grinder configured to maintain the angle of the abrasive article. The system also includes an end effector configured to exert an end effector load on the abrasive article, and receive a reaction force from the abrasive article. The system also includes a motor, with a grinder motor power, that drives rotation of the abrasive article at a rotational speed. The system also includes a setting selector configured to: retrieve the rotational speed, the end effector load and an in-situ grinding parameter, calculate a predicted material removal rate based on the retrieved rotational speed, end effector load and in-situ grinding parameter, and compare the predicted material removal rate to a reference predicted removal rate. The system also includes select a set of new settings for a mechanical setting of the robotic grinding system. The system also includes a setting communicator that communicates the new settings to the grinder, end effector and motor, which automatically adjust operational settings from a set of current settings to the new settings.

The robotic grinding system may be implemented such that the new settings are selected to increase a predicted material removal rate.

The robotic grinding system may be implemented such that in-situ grinding parameter includes a current grinder motor power, and calculates the predicted material removal rate based on the current grinder motor power.

The robotic grinding system may be implemented such that the in-situ grinding parameter includes a reaction force, and calculates the predicted material removal rate based on the reaction force.

The robotic grinding system may be implemented such that it also includes an abrasive article parameter retriever that retrieves an abrasive article color, a grinding sound, a presence of sparking, or a color of sparking.

The robotic grinding system may be implemented such that it also includes an abrasive condition evaluator that evaluates a condition of the abrasive article.

The robotic grinding system may be implemented such that the setting adjuster provides the setting adjustment based on the condition of the abrasive article.

The robotic grinding system may be implemented such that the setting adjustment is provided to reduce a grinding temperature.

The robotic grinding system may be implemented such that the mechanical setting is a press force of the end effector, a grind angle of the grinder, or a lateral speed of a robotic arm.

The robotic grinding system may be implemented such that calculating the predicted material removal rate includes applying a gaussian process regression.

The robotic grinding system may be implemented such that the setting communicator also communicates the new settings to a database in a format available for later retrieval.

The robotic grinding system may be implemented such that the setting communicator also communicates the new settings to a user interface generator for display on a user interface.

The robotic grinding system may be implemented such that the reference predicted removal rate is a predicted removal rate range.

The robotic grinding system may be implemented such that the setting selector periodically retrieves, calculates, compares and selects the set of new settings based on an indication.

The robotic grinding system may be implemented such that the indication is a period of time, a detected operation start time, or an operator command.

### EXAMPLES

### Example 1

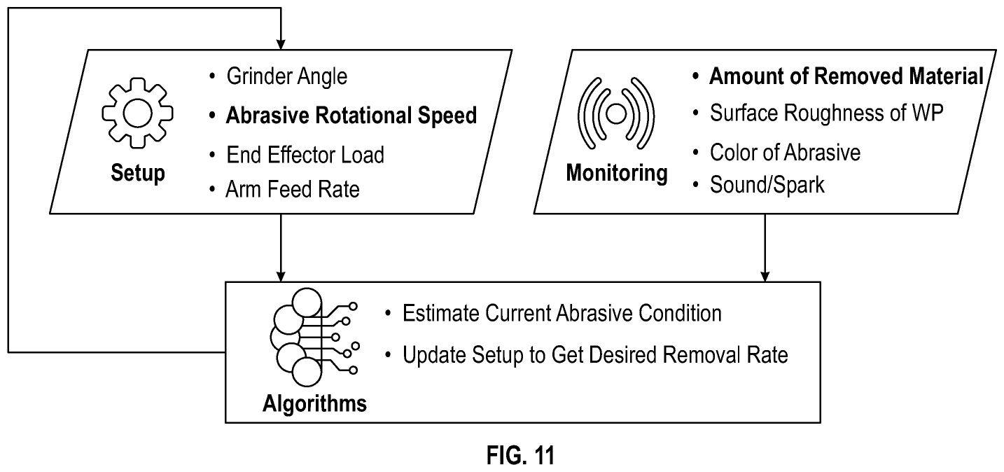

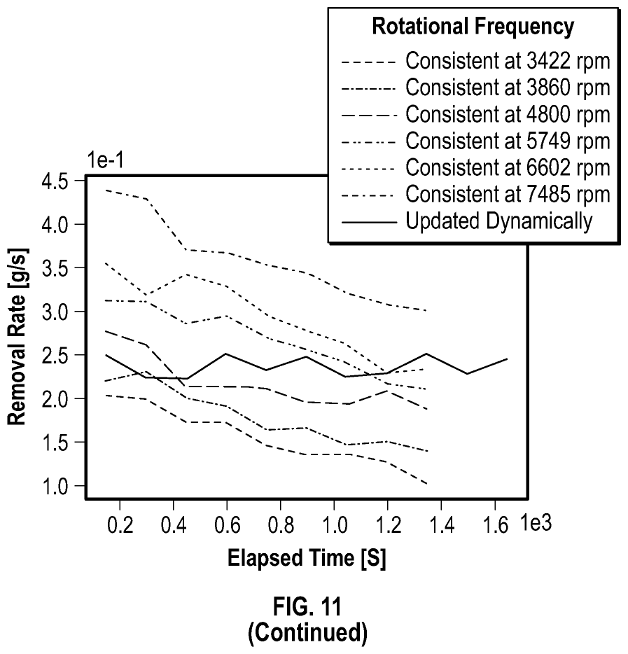

FIG. 11 illustrates an experiment to evaluate a simple feedback algorithm to keep removal rate consistent by changing the rotational speed of an abrasive disc. Experiment 16 was compared to Experiments 8-13, which illustrate conventional force control without feedback.

Using the system like that illustrated in FIG. 1, a robotic repair unit available from Fanuc, and an end effector unit such as that described in Pat. Pub no.: JP2020049599. The abrasive disc used is available from 3M Company under the product designation Cubitron 2™ Fiber Disc 987C. The workpiece was a stainless steel 400 plate, with a width of 6 mm, and a length of 300 mm. The settings of the device were 20 mm/s, a 10° contact angle was used, and a load of 1.45 kgf was applied. This resulted in the experimental runs of FIG. 11.

### Example 2

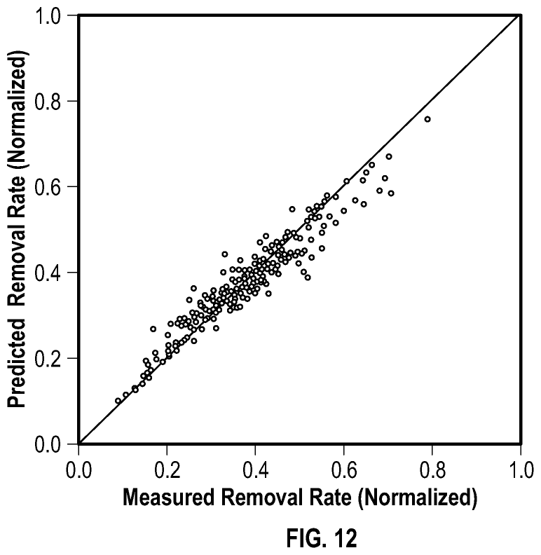

FIG. 12 illustrates simulation results obtained using parameters of the same setup in Example 1. The simulations were conducted to evaluate the performance of the removal rate prediction model by using a variety of historically collected datasets. Power consumed in friction was computed from reaction torque measured at the connection between the arm and the end effector. The additional parameters used were the end effector geometry, workpiece geometry, disc radius, rotational angle, contact angle and feed rate.

The results were normalized to a maximum of 1. The material removal rate is the actual material removal rate measured in a series of historic experiments. The sliding friction power is the estimated power consumed in the horizontal plane due to the sliding friction between the workpiece and abrasive surface. The abrasive rotational frequency combined with load value corresponds to relative velocity multiplied by load in Preston's Law. It was computed by multiplying the two setting values. The wear amount was the weight loss of the abrasive disc. The predicted removal rate is the mean value of the output from the removal rate production model. Since the model is a Gaussian process-based model, the predictions are expressed with mean and standard deviation. The Y-axis of FIG. 12 illustrates the mean value of the Gaussian Process model's output.

1-40. (canceled)

41. A robotic grinding system comprising:
an abrasive article configured to contact a worksurface at an angle;
a grinder configured to maintain the angle of the abrasive article;
an end effector configured to exert an end effector load on the abrasive article, and receive a reaction force from the abrasive article;
a motor, with a grinder motor power, that drives rotation of the abrasive article at a rotational speed;
a setting selector configured to:
retrieve the rotational speed, the end effector load and an in-situ grinding parameter;
calculate a predicted material removal rate based on the retrieved rotational speed, end effector load and in-situ grinding parameter;
compare the predicted material removal rate to a reference predicted removal rate; and
select a set of new settings for a mechanical setting of the robotic grinding system; and
a setting communicator that communicates the new settings to the grinder, end effector and motor, which automatically adjust operational settings from a set of current settings to the new settings.

42. The robotic grinding system of claim 41, wherein the new settings are selected to increase a predicted material removal rate.

43. The robotic grinding system of claim 41, wherein in-situ grinding parameter comprises a current grinder motor power, and calculates the predicted material removal rate based on the current grinder motor power.

44. The robotic grinding system of any of claim 41, wherein the in-situ grinding parameter comprises a reaction force, and calculates the predicted material removal rate based on the reaction force.

45. A grinding setting selection system for a robotic grinding system, the grinding setting selection system comprising:
an abrasive rotational speed retriever that retrieves a current rotational speed of a grinder in the robotic grinding system;
an end effector load retriever that receives a current end effector load of an end effector in the robotic grinding system;
an in-situ parameter sensor that senses an in-situ grinding parameter in a current grinding operation;
a material removal predictor that, based on the retrieved rotational speed, the end effector load and the in-situ grinding parameter, predicts an in-situ material removal rate;
a setting adjuster that, based on the predicted in-situ removal rate, provides a setting adjustment for the robotic grinding system, wherein the setting adjustment alters a mechanical setting of the robotic grinding system; and
a setting communicator that communicates the setting adjustment to the robotic grinding system.

46. The grinding setting selection system of claim 45, wherein the in-situ parameter sensor is a grinder motor power sensor that detects a current grinder motor power, and wherein the material removal predictor predicts the material removal rate based on the current grinder motor power.

47. The grinding setting selection system of claim 45, wherein the in-situ parameter sensor is a reaction force sensor that senses a reaction force exerted by an abrasive article on the end effector, and wherein the material removal predictor predicts the material removal rate based on the reaction force.

48. The grinding setting selection system of claim 45, wherein the material removal rate predictor also predicts the material removal rate based on a press force of the end effector, a grind angle of the grinder, or a lateral speed of a robotic arm.

49. The grinding setting selection system of claim 45, wherein the mechanical setting comprises a new press force for the end effector, a new rotational speed, or a new grind angle.

50. The grinding setting selection system of claim 45, wherein the material removal rate predictor comprises a regression model.

51. The grinding setting selection system of claim 45, wherein the predicted material removal rate is compared to a reference material removal rate and wherein the setting adjuster provides the setting adjustment based on the comparison.

52. A method of adjusting grinding parameters in a robotic grinding system, the method comprising:
receiving a set of current grinding operation parameters, wherein the set of current grinding operation parameters comprises a rotational speed of a grinder a load of an end effector, and a sensed in-situ parameter of the current grinding operation;
estimating a current material removal rate, using a material removal rate predictor, based on the received set of current grinding operation parameters;
selecting a set of new grinding operation parameters for the robotic grinding system based on the estimated removal rate; and
automatically adjusting the robotic grinding system from the current grinding operation parameters to the new grinding operation parameters.

53. The method of claim 52, and further comprising:
calculating a grinding effectiveness, using a grinding effectiveness calculator, by comparing the current material removal rate to an expected material removal rate, and wherein the selected set of new grinding operation parameters is based on the calculated grinding effectiveness.

54. The method of claim 52, wherein the in-situ parameter comprises a sensed reaction force experienced by the end effector.

55. The method of claim 52, wherein the in-situ parameter comprises a sensed current grinder motor power.

56. The method of claim 52, wherein the set of current grinding operation parameters also comprises an abrasive article parameter.

57. The method of claim 52, and further comprising calculating an abrasive article condition based on the abrasive article parameter, and wherein the set of new grinding operation parameters is also based on the calculated abrasive article condition.

58. The method of any of claim 52, wherein the expected material removal rate is a reference material removal rate.

59. The method of any of claim 52, wherein the material removal rate is calculated using a gaussian process regression.

60. The method of any of claim 52, and also comprising communicating the set of new grinding operation parameters to the robotic grinding system, wherein the robotic grinding system is remote from the grinding effectiveness calculator.
